(19) United States
(12) Patent Application Publication
(10) Pub. No.: US 2008/0040125 A1
(43) Pub. Date: Feb. 14, 2008

(54) Apparatus for Revising Corporate Checklist

(75) Inventors: Nobutaka Okabe, Tokyo (JP); Masayuki Satou, Tokyo (JP); Ichirou Hayashi, Tokyo (JP); Hirofumi Kosaka, Tokyo (JP); Masaki Suzuki, Tokyo (JP); Satoko Sakurai, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd., Tokyo (JP)

(21) Appl. No.: 10/594,035

(22) PCT Filed: Mar. 18, 2005
(86) PCT No.: PCT/JP05/05635

§ 371 Date: Jul. 16, 2007

(30) Foreign Application Priority Data
Mar. 30, 2004 (JP) 2004-100051

(51) Int. Cl. G06Q 10/00

(52) U.S. Cl. 705/1

(57) ABSTRACT

An apparatus for supporting revision of a checklist for checking soundness of a company in accordance with revision of the laws and ordinances is provided. The apparatus comprises a first database of a checklist containing check items associated with provisions of laws/ordinances, a second database of laws/ordinances data including texts of provisions, and a computer for supporting revision of the checklist responsive to entry of revision of laws/ordinances. The computer is programmed to produce revision information indicating deletion, addition or updating of respective provisions of the revised laws and ordinances. The computer deletes from/add to the checklist a name of a provision of the laws/ordinances identified by the revision information, and delete a relevant check item when the revision information indicates deletion/add to the checklist a check item associated with the revised provision when the revision information indicates deletion.

### TECHNICAL FIELD

The present invention relates to an apparatus to be used in taking actions for improving soundness of corporate activities and, more specifically, to an apparatus for supporting a revision of a checklist to be used for evaluating corporate soundness.

### BACKGROUND ART

Many companies take various actions for maintaining and improving the soundness of corporate activities. This is because scandals of a company would deteriorate social evaluation of the company and may result in disadvantages to the stockholders. As investment of foreign capital into Japanese companies increases, it has become a common concept that a corporation is owned by the stockholders who invested in the corporation. Such a concept has led to enhancement in the field of corporate governance, compliance, risk management and corporate ethics and many actions have been taken to enhance the soundness of corporate activities. Such actions are managed within a company and each department of the company is required to comply with such actions.

The Japanese Patent Application Publication No. 9-114801 discloses a diagnostic device for quantitatively evaluating a risk about a company who is potential customer of an insurance marketing department. The Japanese Patent Application Publication No. 2003-99431 discloses a system for providing a user with manual information indicating compliance manuals when requested by a user. Manual data indicate compliance manuals for each department and each year. The Japanese Patent Application Publication No. 2003-248752 discloses a management diagnosis system including a check sheet describing a plurality of check items to be used for diagnosis and a planning sheet to be used for performing improvement activities based on the diagnostic result.

Recently, corporate activities extend over various areas. As the size of a company increases, the variation of operations increases proportionally. As the activity areas and the variation of operations increase, the number of laws with which the company must comply increases as well.

On the other hand, in order for a company to comply with the laws, there is a system for creating a checklist for listing up actions to be taken relative to problems which the company should cope with. The system manages the checklist with the use of a database. The checklist managed by such system is created referring to the underlying laws and regulations. However, since these laws and regulations are sometimes revised, the checklist must be revised in accordance with the revision of the laws and regulations. Nowadays, due to many laws and regulations for a company to comply with, the revision work becomes complicated. Accordingly, there is a need for an apparatus for supporting revision work and simplifying the revision work.

Considering the above-described current situation, it is an objective of the present invention to provide an apparatus for supporting a revision work to cope with the revision of the laws and regulations so as to maintain a checklist in a most up-to-date and optimal condition.

### DISCLOSURE OF INVENTION

The present invention provides an apparatus for supporting revision of a checklist for checking soundness of a company in accordance with revisions of the laws and regulations.

The apparatus comprises a first database of a checklist containing check items associated with provisions of laws and ordinances, a second database of laws/ordinances data including texts of provisions, and a computer for supporting revision of the check list responsive to entry of revision of laws and ordinances. The computer is programmed to produce revision information indicating deletion, addition or updating of respective provisions of the revised laws and -ordinances. The computer is also programmed to delete from the checklist a name of a provision of the laws/ordinances identified by the revision information and delete a relevant check item when said revision information indicates deletion. The computer is further programmed to add to the checklist a name of a provision of the laws/ordinances identified by the revision information and add to the checklist a check item associated with the revised provision when said revision information indicates addition. The computer is also programmed to replace a relevant check item in the checklist associated with the revised provision of the laws/ordinances identified by the revision information with the text of the revised provision when said revision information indicates updating.

According to the invention, revision of the checklist is supported for deleting, updating check points or adding check point columns as law and regulation is revised, thus simplifying revision of the checklist.

### BRIEF DESCRIPTION OF DRAWINGS

FIG. 1 shows a block diagram of a structure of an apparatus for supporting revision of corporate diagnosis list in accordance with one embodiment of the present invention.

FIG. 2 shows a flowchart of a corporate diagnosis list revision supporting process in accordance with one embodiment of the present invention.

FIG. 3 shows an example of a master checklist in accordance with one embodiment of the present invention.

FIG. 4 shows an example of data stored in a job classification-check item database in accordance with one embodiment of the present invention.

FIG. 5 shows an example of data stored in a departmental checklist database in accordance with one embodiment of the present invention.

FIG. 6 shows an example of data stored in a department-job classification database in accordance with one embodiment of the present invention.

### BEST MODE FOR CARRYING OUT THE INVENTION

### 1. Structure of Apparatus

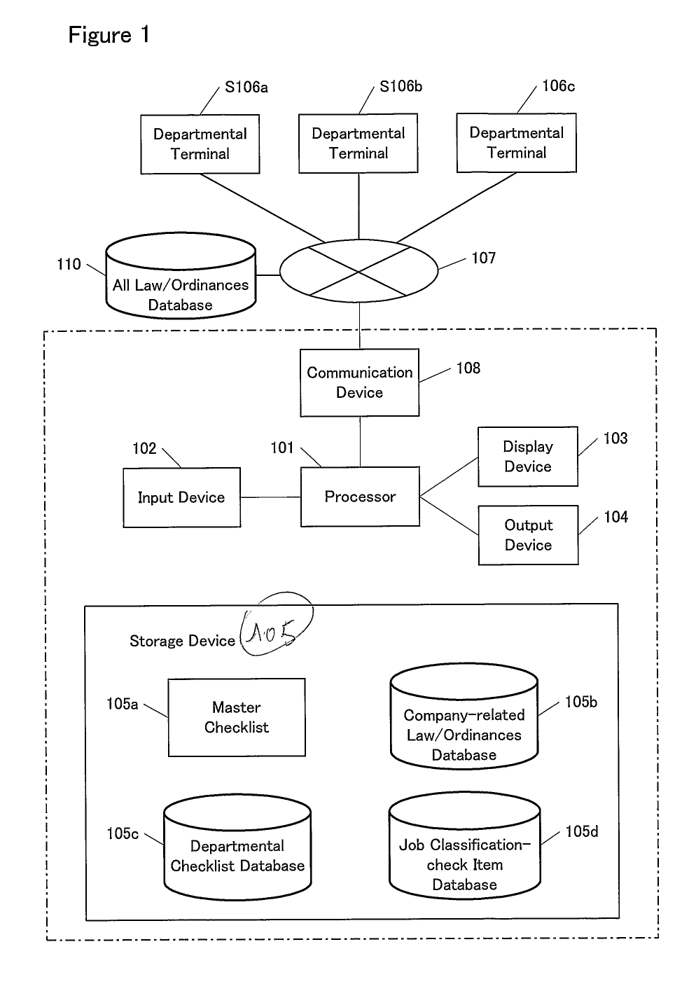

An embodiment of a corporate diagnosis list revision supporting apparatus in accordance with the present invention will be described below with reference to the accompanying drawings. FIG. 1 shows a structure of a corporate diagnosis list revision supporting apparatus 10 in accordance with one embodiment of the present invention. The revision supporting apparatus 10 has a processor 101, an input device 102, a display device 103, an output device 104, a storage device 105 and a communication device 108. These devices are interconnected through the central processor 101.

The processor 101 is, for example, a CPU, which executes operations and conditional branches in accordance with a program. In this embodiment, the processor 101 materializes a revision support process and various databases (to be described later). The input device 102 includes, for example, a keyboard and a mouse for inputting data to the revision supporting apparatus and for operating the apparatus. The input device 102 is connected to the processor 101 through a serial interface.

The display device 103 is, for example, a display, which serves to display various kinds of information that is outputted by the revision supporting apparatus. The display device 103 is connected to the processor 101 through a graphic interface. The output device 104 is, for example, a laser printer, which serves to print various diagnosis lists that are outputted from the revision supporting apparatus. The output device 104 is connected to the processor 101 through a parallel interface or a network.

The storage device 105 is, for example, a hard disk, which stores data for various databases that are used in the revision supporting apparatus. The storage device 105 stores computer programs for the databases and for executing a revision supporting process (to be described later). The databases used in this embodiment are relational databases. The storage device 105 is connected to the processor 101 through a SCSI interface. The revision supporting apparatus according to this embodiment may include plural storage devices. Besides, the stored databases may be distributed into the plural storage devices. According to this embodiment, the storage device stores a master checklist 105a, a corporate laws/ordinances DB (database) 105b, a departmental checklist DB 105c, a job classification-check item DB 105d, laws/ordinances-job classification DB (not shown), a revision information DB (not shown), a corporate laws/ordinances information DB (not shown) and a department-job classification DB (not shown).

The communication device 108 is, for example, a network interface card (NIC) such as a LAN card, which serves to connect the supporting apparatus to a network 107.

The network 107 is the Internet that connects the supporting device to an intranet that is constructed within the company as well as an outside facility. The network 107 is connected to some departmental terminals 106 within the company and an external all-laws/ordinances DB 110. Each of he departmental terminals 106 is a terminal installed in each department, which has a function of displaying the information transmitted from the supporting apparatus 10 on its screen.

The all-laws/ordinances DB 110 is a database for storing the laws and regulations in an electronic file format. It stores all of the laws and regulations. The all-laws/ordinances DB 110 is managed outside of the company such that any revision of the laws and regulations is immediately reflected to the DB 101. The electronic recording format may be a XML-form file with tags for the provisions or a HTML-form file. According to this embodiment, each of the laws and regulations is stored as a separate file.

The corporate laws/ordinances DB 105b is a database for storing the laws and regulations in an electronic file format. It stores only the laws and regulations to be used within the company. This database 105b is managed within the company so as to reflect every relevant revision of the laws and regulations by the revision supporting process (to be described later) through the communication with the all-laws/ordinances DB. Similarly as in the all-laws/ordinances DB 110, the electronic recording format for the corporate DB 105b may be a XML-form file with tags for the provisions or a HTML-form file. Also, according to this embodiment, each of the laws and regulations in this DB 105a is stored as a separate file.

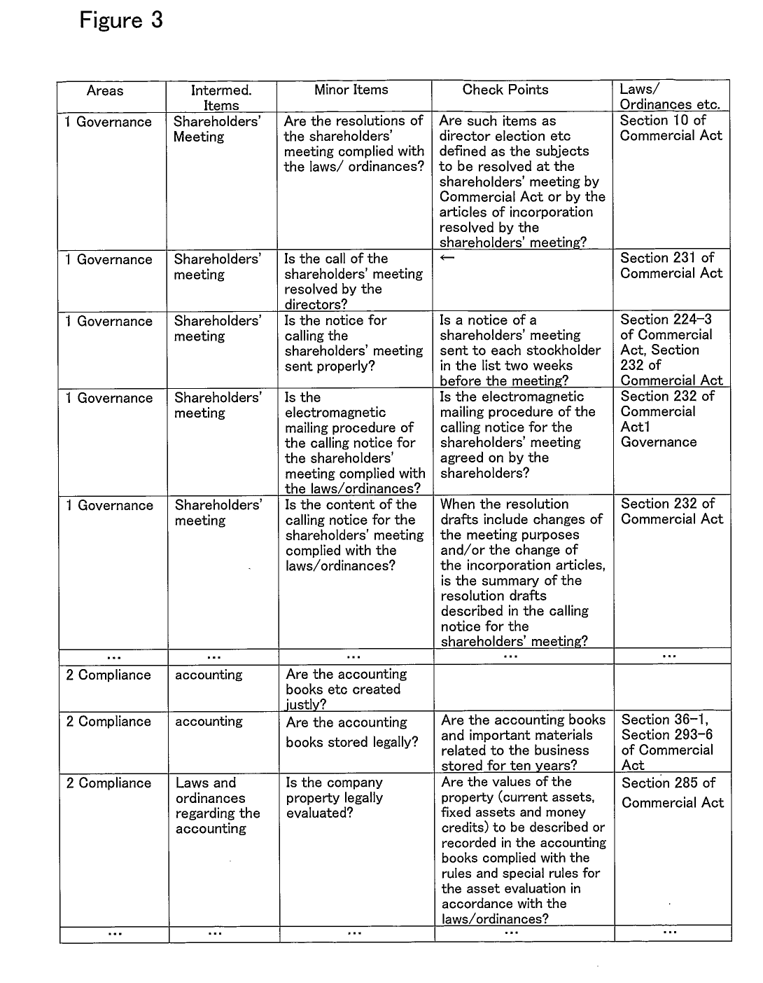

FIG. 3 shows an example of the data on the master checklist stored in the master checklist DB 105a. The master checklist is a list in which the items to be complied within the company are classified in a query format for each of areas (to be described later). The master checklist has such fields as “area”, “intermediate item”, “minor item”, “check point” (check items) and “underlying laws/ordinances”. The data in the horizontally adjacent fields are associated each other. The “area” is classified into four areas of governance, compliance, risk management and corporate ethics. Each area further includes plural “intermediate items”. Each intermediate item includes plural “minor items”. Each minor item is associated with the corresponding “check points”. Further, each “check point” is associated with the corresponding “underlying laws/ordinances”.

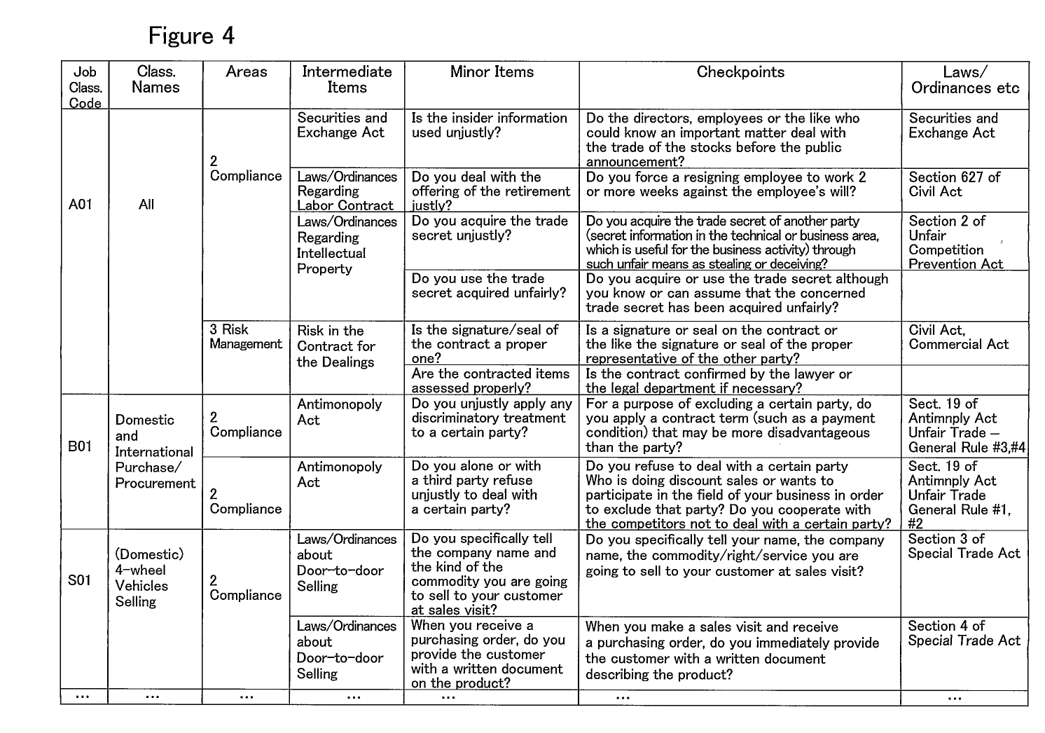

FIG. 4 shows an example of the data item names (field names) of the job classification-check item DB 105d and those data. The job classification-check item DB 105d is a database in which the check points are extracted for each job classification from the master checklist. Accordingly, some fields in the DB 105d are duplicated with those in the master checklist. The DB 105d has such fields as “job classification codes”, “classification names”, “areas”, “intermediate items”, “minor items”, “check points” and “underlying laws/ordinances etc”. The data in the horizontally adjacent fields are associated with each other. The classification names are for the jobs or works within the company. The job classification codes are alphanumeric codes representing the classification names of the jobs within the company. Each code is unique. Each classification name is associated with one or plural “areas”. The “areas” include four areas of governance, compliance, risk management and corporate ethics. Each area further includes plural “intermediate items”. Each area is associated with one or plural intermediate items. Each intermediate item represents a name of the laws/ordinances corresponding to the corresponding minor item (to be described later). Each minor item represents an outline of the content to be checked. Each minor item has a one-to-one correspondence with a check point. Each check point is a query item for determining whether or not the content described in the minor item is applicable. Further, each check point is associated with a name of the underlying law/ordinance or the underlying provision which should be a base for the check point.

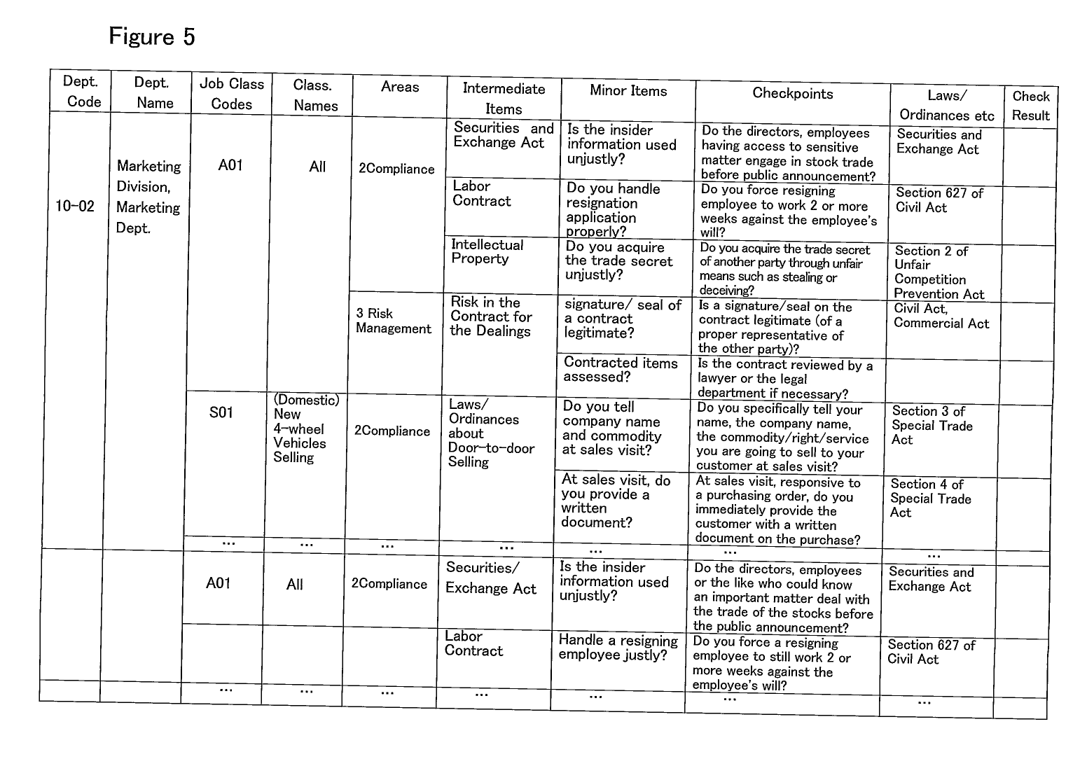

FIG. 5 shows an example of the data item names (field names) of the departmental checklist DB 105c and those data. The departmental checklist DB 105c contains a checklist in which the check points to be checked by each department are extracted from the job classification DB and the job classification and check item DB through a predetermined process. The departmental check list includes such field s as “department codes”, “department names”, “job classification codes”, “classification names”, “areas”, “intermediate items”, “minor items”, “check points” and “underlying laws/ordinances etc”. The data in the horizontally adjacent fields are associated each other. This checklist is distributed to each department and used for verifying whether the check points are observed.

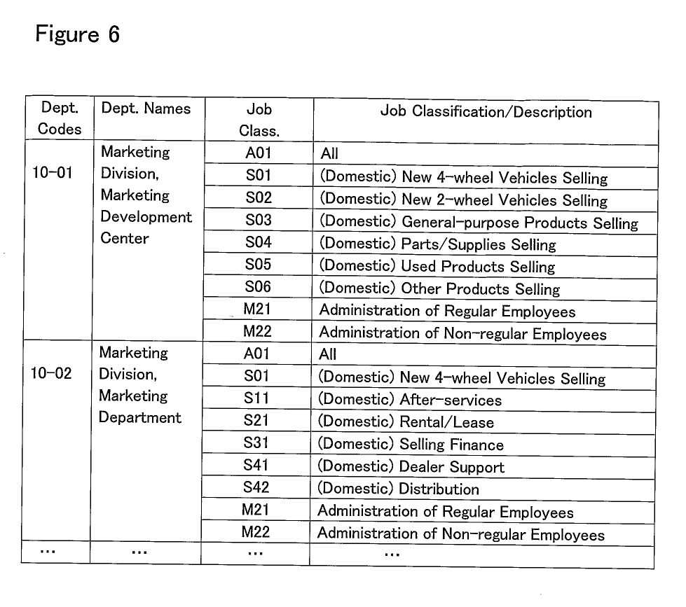

FIG. 6 shows an example of the data item names (field names) of the department-job classification DB and those data. The department and job classification DB is a database in which “job classifications” are associated with each “department”. As shown in FIG. 6, the department and job classification DB according to this embodiment includes such fields as “department codes”, “department names”, “job classification codes” and “job classification/description”. The data in the horizontally adjacent fields are associated each other. Each department code is an alphanumeric code representing each of the departments in the company. Each department is assigned a unique code. In this embodiment, a department represents a management unit of controlling several operations in the company. Besides, a job classification is a classification for the works or jobs in the company. Each job classification is assigned a unique job classification code. Each department is associated with one or plural job classifications. One job classification may belong to plural departments. For example, a job of “(domestic) sales of new 4-wheel vehicles” belongs to both of the “sales department of the marketing division” and the “marketing development center of the marketing division”.

Additionally, the storage device 105 provides a revision information DB, a corporate laws/ordinances information DB and a laws/ordinances and job classification DB (not shown in the accompany drawings). Revision information of the laws/ordinances such as addition, deletion or update is associated with the name of the revised laws/ordinances or the revised provision in the revision supporting process (to be described later).

The corporate laws/ordinances information DB stores the names of the laws/ordinances and the revisions which are related with the company to be used for determining, based on the name of a laws/ordinances or a provision, whether or not that laws/ordinances or provision is related with the operations of the company.

The laws/ordinances and job classification DB in which the names of the provisions of the laws/ordinances are associated with the “job classifications” so that it is determined to which job an added provision of a laws/ordinances is related when the provision is added in accordance with the revision of the laws/ordinances.

### 2. Execution Process

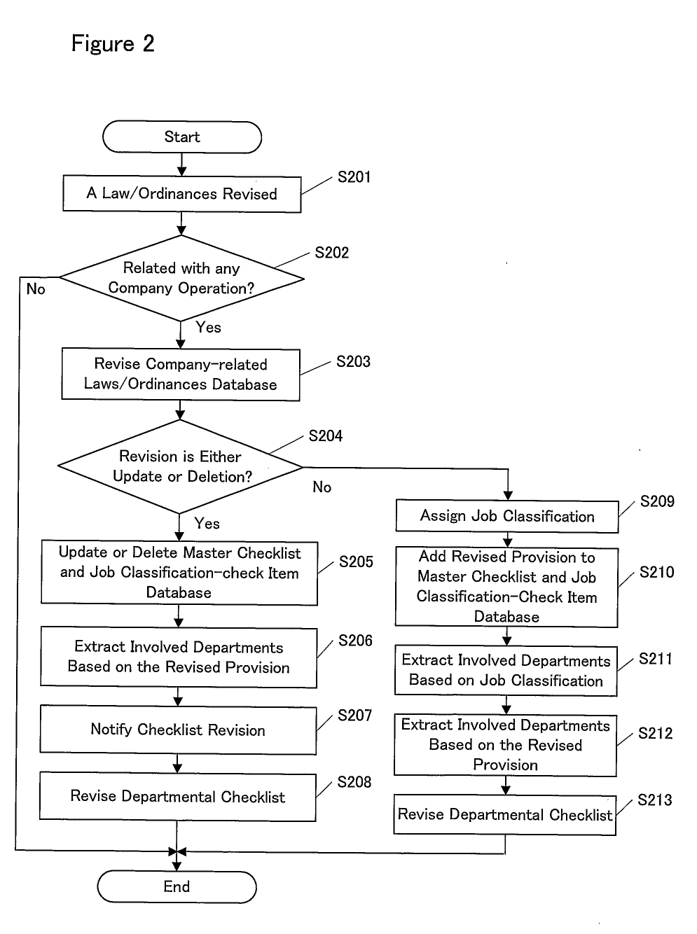

The process of revising corporate diagnosis list will now be described with reference to a flowchart of FIG. 2.

When a laws/ordinances is revised, a provision file, which is stored in the all-laws/ordinances DB 110 and associated with the revised laws/ordinances, is updated. After the provision file is updated, the fact of the revision and the name of the revised laws/ordinances are transmitted from the all-laws/ordinances DB 110. Upon reception of such information, the processor 101 determines whether or not the revised laws/ordinances relate to the company operations (S202). Specifically, the processor 101 looks up the corporate laws/ordinances information DB (not shown) to determine whether or not the revised laws/ordinances and the revised provision are included in the DB. When the revised laws/ordinances and the revised provision are not included in the corporate laws/ordinances information DB, it indicates that the revision has been made upon the matter that is not related to any of the company operations. Thus, when the revised laws/ordinances do not relate to the company operations, the processor 101 terminates this process. On the other hand, when the revised laws/ordinances and the revised provision are included in the corporate laws/ordinances information DB (in other words, when the revision has been made upon the matter related to the company operations), the process proceeds to S203.

When the laws/ordinances relating to company operations have been revised, the processor 101 looks up the XML tag and the file name of the revised provision to identify the revised laws/ordinances and the revised provision. Then, the processor 101 determines whether the revision is either addition, deletion or update, and associates the revised laws/ordinances, the revised provision and the revised content (addition, deletion or update) all together with each other. Processor 101 stores the associated information as revision information in the revision information DB of the storage device 105. After storing the revision information, the processor 101 revises the laws/ordinances file stored in the corporate laws/ordinances DB 105b (S203). The revision of the laws/ordinances may be made either by transferring the revised and new laws/ordinances file to the corporate laws/ordinances DB and deleting the old file or by replacing the character strings corresponding to the revised portion within the file.

Next, in S204, the processor 101 refers to the revision information of the revision information DB to determine whether the revision of the laws/ordinances has been an update or a deletion. When the revision type is an update or a deletion, the processor 101 proceeds the process to S205.

The processor 101 performs an update or a deletion upon the master checklist DB and the job classification and check item DB based on the revision information (S205). More specifically, when the revision information indicates a deletion, the processor 101 identifies the provision name of the laws/ordinances information indicating the deletion and deletes the “underlying laws/ordinances etc” of that provision and the “check point” associated that “underlying laws/ordinances etc” from the master checklist DB and the job classification-check item DB. Besides, if necessary, the “minor item”, the “intermediate item” and the “area” which are associated with that check point are deleted from the master checklist DB and the job classification and check item DB.

When the revision information indicates an update, the processor 101 identifies the names of the relevant laws/ordinances and the provision to update the “check point” associated with the “underlying laws/ordinances etc” identified by the names. The update is performed by replacing the check point with the provision content of the provision indicated by the revision information. In many cases, since the check point is created based on the text of the provision, the check point can be updated by rewriting the predetermined portion of the provision text (such as the end portion of the text). By replacing a check point with the text of the revised provision, the “check point” associated with the revised provision can readily be updated. Besides, by displaying an editing screen for the master checklist by the display device 103 after the update of the check point, the rewritten portion can be edited through the input device 102.

The processor 101 searches the job classification and check item DB 105d to identify the job classification covering the check point that is associated with the name of the law and regulation and the name of the provision indicated by the revision information. When the job classification is identified, the processor 101 searches the department and job classification DB to identify the departments to which the identified job classification belongs (S206). For example, when article 3 of a specific commercial transaction law in the field of the “underlying laws/ordinances etc” in FIG. 4 has been revised, the processor 101 identifies the job of “(domestic) sales of new 4-wheel vehicles” and looks up the department and job classification DB (FIG. 6) to identify the “sales department of the marketing division” and the “marketing development center of the marketing division”.

When relevant departments are identified, the processor transmits the notice of the revision of the checklist to the terminals 106 belonging to the identified departments (S207). Such revision notice is displayed on the terminals of the departments. In the same manner as in S205, the revised laws/ordinances etc are identified so that the departmental checklist DB 105e can be revised (S208). Then, this process is terminated.

On the other hand, when the revision is neither update nor deletion (in other words, when the new provision has been added according to the revision), the processor 101 identifies the name of the laws/ordinances containing the revised provision and searches the laws/ordinances and job classification DB (not shown) to identify the job classification name of the operation associated with the identified laws/ordinances (S209).

When one or more job classifications are identified, the processor 101 adds a new check point associated with the name of the laws/ordinances and the underlying provision to the master checklist. Besides, the processor 101 adds a new check point associated with the identified job classification to the job classification and check item DB (S210). The new check point is added to the job classification and check item DB can be added as follows. First, the “underlying laws/ordinances etc” having a provision name is identified in the job classification and check item DB, which is closest to the provision name of the laws/ordinances name indicated by the revision information among the job classifications identified by the processor 101 in S209. Then, the underlying laws/ordinances that has been added according to the current revision are inserted below the “underlying laws/ordinances etc” having the closest provision name, and a new check point description is created which is associated with the inserted laws/ordinances. When the new check point description is added in the master check point DB and the job classification and check item DB, the check point may be blank or the added provision may be filled in that check point. As described above, in many cases, since the check point is created based on the text of the provision, the check point can be updated by rewriting the predetermined portion of the provision text (such as the end portion of the text). By using the text of the revised provision as a check point description, a “check point” can readily be created. Besides, by displaying an editing screen for the master checklist with the display device 103 when a check point is added, a user may edit the added portion using the input device 102. Subsequently, the processor 101 searches the department and job classification DB (FIG. 6) to identify the name of the department to which the identified job classification belongs (S211). For example, when the job classification is the “(domestic) sales of new 4-wheel vehicles”, the “sales department of the marketing division” and the “marketing development center of the marketing division” are identified as department names.

When relevant departments are identified, the processor transmits the notice of the revision of the checklist to the terminals 106 belonging to the identified departments (S212). Such revision notice is displayed on the terminals of the departments. Then, in the same manner as in S205, as revised laws/regulation etc is identified, the departmental checklist (FIG. 5) can be revised (S213). Then, this process is terminated.

Thus, the checklist editing work can be simplified because the revised laws/ordinances and provision are identified and the creation of the checklist is supported so as to delete or update the check point associated with the revision or to add a new checkpoint description.

1-2. (canceled)

3. An apparatus for supporting revision of a checklist for checking soundness of a company in accordance with revision of the laws and ordinances, the apparatus comprising:
a first database of a checklist containing check items for checking conformity by each of a plurality of departments of the company with the relevant laws and ordinances, said check items associated with names of the provisions of laws and ordinances,
a second database of laws/ordinances data including texts of provisions; and
a computer for supporting revision of the check list responsive to entry of revision of laws and ordinances; and
means for connecting said computer to an external database containing newest provisions of laws and ordinances for receiving revision information relative to the provisions of laws and ordinances:
said computer being configured to:
responsive to receipt of said revision information determine whether the revision relate to the laws/ordinances stored in said second database;
if the determination is positive and the revision relates to deletion, delete from the checklist in said first database the name of the provision of the laws/ordinances identified by the revision information and delete relevant check item;
if the determination is positive and the revision relates to addition, add to the checklist in said first database the name of the provision of the laws/ordinances identified by the revision information and add to the checklist a check item associated with the added provision; and
if the determination is positive and the revision relates to updating, replace a relevant check item in the checklist associated with the updated provision of the laws/ordinances identified by the revision information with the text of the updated provision; and
send signals via an intranet to the departments notifying the revision of the checklist.

4. A computer implemented method of supporting revision of a checklist for checking soundness of a company in accordance with revision of the laws and ordinances, said checklist being stored in a first database and containing check items for checking conformity by each of a plurality of departments of the company with the relevant laws and ordinances, said check items associated with names of the provisions of laws and ordinances, texts of said relevant laws and ordinances being stored in a second database, the computer carrying out the steps of:
connecting the computer to an external database containing newest provisions of laws and ordinances and receiving revision information relative to the provisions of the relevant laws and ordinances stored in the second database;
if the revision information indicates deletion, deleting from the checklist the name of the provision of the laws/ordinances identified by the revision information and delete the relevant check item;
if the revision information indicates addition, adding to the checklist the name of the provision of the laws/ordinances identified by the revision information and add to the checklist the check item associated with the revised provision;
if the revision information indicates updating, replacing the relevant check item in the checklist associated with the revised provision of the laws/ordinances identified by the revision information with the text of the revised provision; and
sending signals via an intranet to the departments notifying the revision of the checklist.
